(19) United States
(12) Patent Application Publication
(10) Pub. No.: US 2016/0060383 A1
(43) Pub. Date: Mar. 3, 2016

(54) EPOXY RESIN COMPOSITIONS

(71) Applicant: BLUE CUBE IP LLC, Midland, MI (US)

(72) Inventors: Yue SHEN, Shanghai (CN); Yan WU, Shanghai (CN); Fu ZHAN, Shanghai (CN); Fengzhe SHI, Shanghai (CN); Liang HONG, Shanghai (CN)

(73) Assignee: BLUE CUBE IP LLC, Midland, MI (US)

(21) Appl. No.: 14/780,643

(22) PCT Filed: May 10, 2013
(86) PCT No.: PCT/CN2013/075433

§ 371 Date: Sep. 28, 2015

(51) Int. Cl. C08G 59/02; C08G 59/50; C09D 163/00

(52) U.S. Cl. CPC C08G 59/02; C09D 163/00; C08G 59/5033

(57) ABSTRACT

A novel epoxy resin composition capable of forming a coating composition with a high volume solids content; a coating composition comprising such novel epoxy resin composition capable of providing a resultant coating films with balanced properties including good flexibility, good chemical resistance, short dry-hard time, desirable hardness, and good anti-corrosion performance; and the process of preparing the compositions.

### FIELD OF THE INVENTION

The present invention relates to an epoxy resin composition. The present invention also relates to a curable coating composition comprising the epoxy resin composition.

### INTRODUCTION

Epoxy resins are widely used in coating applications such as anti-corrosion coatings. Currently, widely used epoxy-based anti-corrosion coatings are based on conventional bisphenol A epoxy resins and polyamide curing agents, which can provide coating films with flexibility and chemical resistance sufficient to meet industrial requirements. However, such coatings usually cure slowly or even cannot cure at low temperature, for example, lower than 5 degree Celsius (° C.). Adding catalysts into these coatings can only decrease curing temperature to around 0° C. This curing temperature limitation may result in delayed production and/or defects in coating films such as cracking or detaching from a substrate, especially when coating compositions are applied under low temperature conditions.

Phenalkamine curing agents are capable of curing epoxy resins at lower temperature and providing faster drying speed than polyamide curing agents can. Unfortunately, the combination of phenalkamine curing agents with conventional solid epoxy resins usually compromises the flexibility of the resultant coating films Flexibility is one of the key properties for coating films to resist cracking.

Attempts have been made to increase the flexibility of coating films made from phenalkamine and conventional solid epoxy resins. For example, reactive and/or non-reactive diluents are added to coating compositions. Unfortunately, adding these diluents usually increases the cost of coating compositions and compromises their drying property. The chemical resistance properties of the resultant coating films may also be compromised.

Additionally, it is always desirable for coating compositions to have its solids content as high as possible in order to minimize the use of organic solvent. End-users also expect to apply such coating compositions with incumbent application means such as spray guns, paint brushes or paint rollers. Compared to solid epoxy resins, liquid epoxy resins have lower viscosity and are able to provide coating compositions with higher solids content, but the flexibility of the resultant coating films are usually poorer.

There are also other desirable properties for coating applications, such as hardness and corrosion resistance. Anti-corrosion coating films are typically required to have a pendulum hardness of at least 60 seconds as measured by the ISO 1522 method, and to have anti-corrosion performance that meet international standards such as the ISO 12944 standard.

Therefore, it is desirable to provide an epoxy resin composition suitable for coatings that is free from the challenges associated with conventional solid or liquid epoxy resins cured by phenalkamine curing agents. It is also desirable that such epoxy resin composition is able to form a coating composition with high volume solids, for example, at least 60% volume solids content for heavy duty anticorrosive coating compositions. It is further desirable to provide a coating composition which cures at a temperature of 0° C. or lower to produce coating films with balanced flexibility and chemical resistance without compromising the drying property of the coating composition. Moreover, it is desirable to provide a coating composition suitable for anti-corrosion coatings that can provide coating films with the above described hardness and anti-corrosion property.

### SUMMARY OF THE INVENTION

The present invention provides a novel epoxy resin composition that offers a solution to the problems described above. The present invention also provides a coating composition comprising the epoxy resin composition of the present invention and a phenalkamine curing agent to achieve a volume solids content of at least 60%. A coating film made from the coating composition of the present invention has several advantages. For example, it has better flexibility, as compared to that of conventional solid epoxy and/or liquid epoxy resins-based coating compositions. Such coating film of the present invention has good chemical resistance, as evidenced by no blister after being immersed in 10% sodium hydroxide (NaOH) or 10% sulfuric acid (H₂SO₄) solution for at least 7 days according to the ISO 4628/1 method. The coating composition of the present invention has shorter dry-hard time compared with conventional liquid epoxy resins-based coating compositions. Moreover, the coating composition of the present invention is suitable for anti-corrosion coatings and is able to afford coating films with a pendulum hardness of at least 60 seconds as measured by the ISO 1522 method and good anti-corrosion performance to sustain at least 600 hours salt-spray testing as determined by the ASTM B-117 method.

In a first aspect, the present invention is an epoxy resin composition comprising, based on the total weight of the epoxy resin composition,
(a) from 35 to 75 weight percent of a first epoxy resin of Formula (I):

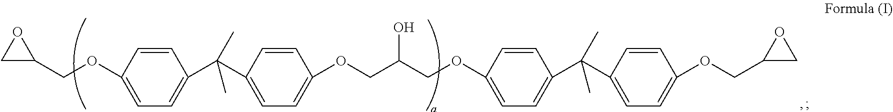

(b) from 5 to 50 weight percent of a second epoxy resin of Formula (II):

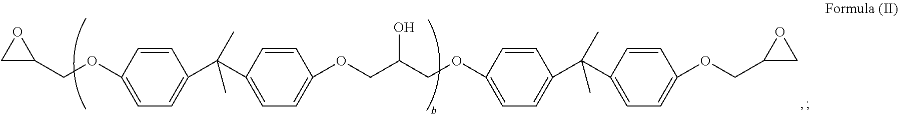

(c) from 4 to 50 weight percent of a first modified epoxy compound of Formula (III):

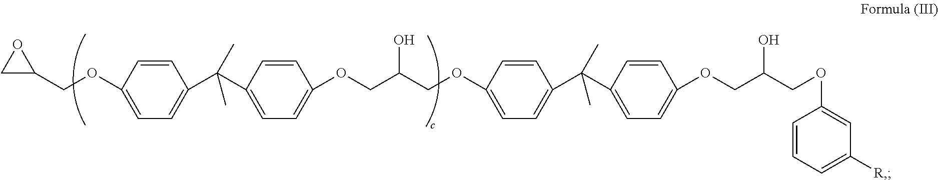

wherein a is 0 or 1; b is 2 or 3; c is 0, 1, 2 or 3; R is a straight-chain alkyl with 15 carbons containing 0 to 3 C═C bond(s) selected from the group consisting of —C₁₅H₃₁, —C₁₅H₂₉, —C₁₅H₂₇, and —C₁₅H₂₅.

In a second aspect, the present invention is a curable coating composition comprising (I) the epoxy resin composition of the first aspect, and (II) a curing agent comprising a phenalkamine compound, its adduct, or mixtures thereof.

### DETAILED DESCRIPTION OF THE INVENTION

The epoxy resin composition of the present invention comprises (a) one or more first epoxy resin of Formula (I):

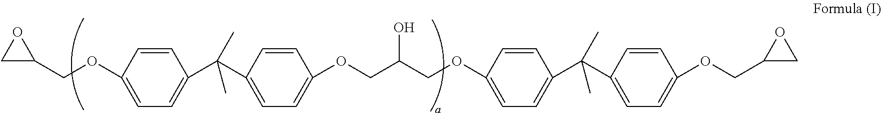

wherein a is 0 or 1, preferably a is 0.

The first epoxy resin of Formula (I), as component (a), is generally a liquid epoxy resin. The term “liquid epoxy resin” herein refers to an epoxy resin in a liquid state without adding any solvent at room temperature (from 21 to 25° C.). The first epoxy resin useful in the present invention may be a mixture of at least two different epoxy resins all having the structure of Formula (I).

The first epoxy resin in the epoxy resin composition of the present invention may have an epoxide equivalent weight (EEW) of 150 or more, preferably 160 or more, and more preferably 170 or more. At the same time, the EEW of the first epoxy resin is desirably 250 or less, preferably 220 or less, more preferably 210 or less, and most preferably 195 or less.

The concentration of the first epoxy resin in the epoxy resin composition, based on the total weight of the epoxy resin composition, is desirably 35 wt % or more, preferably 45 wt % or more, and more preferably 55 wt % or more. At the same time, the concentration of the first epoxy resin is desirably 75 wt % or less, preferably 70 wt % or less, and more preferably 65 wt % or less.

Suitable commercially available first epoxy resins useful in the present invention include, for example, D.E.R.™ 331 (D.E.R. is a trademark of The Dow Chemical Company), D.E.R. 332, D.E.R. 330, D.E.R. 383 epoxy resins, all available from The Dow Chemical Company, and mixtures thereof.

The epoxy resin composition of the present invention also comprises (b) one or more second epoxy resin having the following Formula (II):

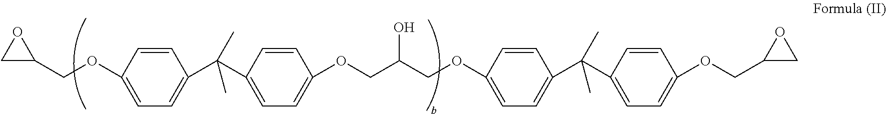

wherein b is 2 or 3, and preferably b is 2.

The second epoxy resin of Formula (II), as component (b), is generally a solid epoxy resin. The term “solid epoxy resin” herein refers to an epoxy resin in a solid state without adding any solvent at room temperature. The second epoxy resin useful in the present invention may be a mixture of at least two different epoxy resins all having the structure of Formula (II).

The second epoxy resin in the epoxy resin composition of the present invention may have an EEW of 350 or more, preferably 400 or more, and more preferably 450 or more. At the same time, the EEW of the second epoxy resin is desirably 750 or less, preferably 600 or less, and more preferably 550 or less.

The concentration of the second epoxy resin in the epoxy resin composition, based on the total weight of the epoxy resin composition, is desirably 5 wt % or more, preferably 7 wt % or more, more preferably 10 wt % or more, and most preferably 15 wt % or more. At the same time, the concentration of the second epoxy resin is desirably 50 wt % or less, preferably 40 wt % or less, more preferably 35 wt % or less, and most preferably 25 wt % or less.

Suitable commercially available second epoxy resins useful in the present invention include for example D.E.R. 671 resin available from The Dow Chemical Company.

The epoxy resin composition of the present invention further comprises (c) one or more first modified epoxy compound of the following Formula (III):

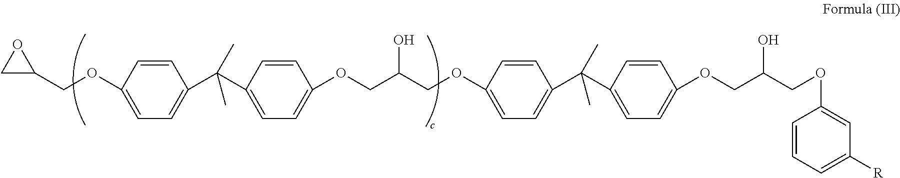

wherein c is 0, 1, 2 or 3; R is a straight-chain alkyl with 15 carbons containing 0 to 3 C═C bond(s) selected from the group consisting of —C₁₅H₃₁, —C₁₅H₂₉, —C₁₅H₂₇, and —C₁₅H₂₅.

The first modified epoxy compound of Formula (III), as component (c), herein is also called “cardanol-modified epoxy resin.” The first modified epoxy compound may be a mixture of at least two different modified epoxy compounds of Formula (III).

The first modified epoxy compound in the epoxy resin composition of the present invention desirably has an EEW of 580 or more, preferably 600 or more, and more preferably 630 or more, and at the same time, desirably 2,000 or less, preferably 1,500 or less, and more preferably 1,300 or less.

The first modified epoxy compound in the epoxy resin composition of the present invention may be (i) a compound having Formula (III), wherein c is 0 or 1, and preferably c is 0. The first modified epoxy compound in the epoxy resin composition of the present invention may be (ii) a compound having Formula (III), wherein c is 2 or 3, and preferably c is 2. The first modified epoxy compound in the epoxy resin composition of the present invention can also be a mixture of the compound (i) and the compound (ii) described above.

Preferably, the first modified epoxy compound comprises, or in some embodiments of the present invention, consists of the following two epoxy compounds:

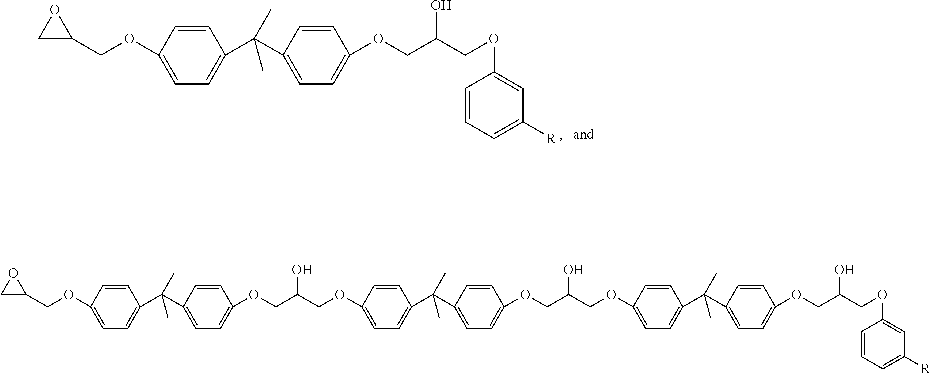

The total concentration of the first modified epoxy compound in the epoxy resin composition, based on the total weight of the epoxy resin composition, is desirably 4 wt % or more, preferably 7 wt % or more, more preferably 10 wt % or more, and most preferably 15 wt % or more. At the same time, the concentration of the first modified epoxy compound is desirably 50 wt % or less, preferably 45 wt % or less, more preferably 40 wt % or less, and most preferably 30 wt % or less.

In one embodiment of the present invention, the epoxy resin composition of the present invention further comprises (d) a second modified epoxy compound of Formula (IV):

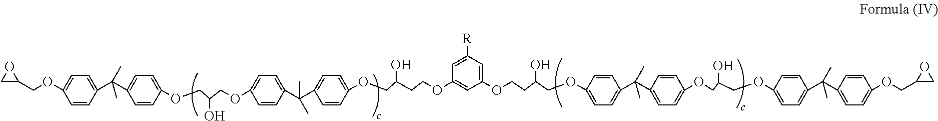

wherein c and R are independently as previously defined with reference to Formula (II).

The second modified epoxy compound of Formula (IV), as component (d), herein is also called “cardol-modified epoxy resin.” The presence of the second modified epoxy compound can further shorten the drying time of the epoxy resin composition and/or increase the flexibility of the resultant coating film.

When present in the epoxy resin composition of the present invention, the second modified epoxy compound is present, based on the total weight of the epoxy resin composition, in an amount of 0.5 wt % or more, preferably 1.5 wt % or more, more preferably 2 wt % or more, and most preferably 3 wt % or more. At the same time, the concentration of the second modified epoxy compound is desirably 50 wt % or less, preferably 40 wt % or less, more preferably 35 wt % or less, and most preferably 25 wt % or less.

The total concentration of the first and second modified epoxy compounds is, based on the total weight of the epoxy resin composition, desirably 4 wt % or more, preferably 7 wt % or more, and more preferably 10 wt % or more. At the same time, the total concentration of the first and second modified epoxy compounds is desirably 70 wt % or less, preferably 60 wt % or less, and more preferably 50 wt % or less.

Preferably, the epoxy resin composition of the present invention comprises the first epoxy resin described above, the second epoxy resin described above, and a reaction product of cashew nut shell liquid (“CNSL”) with the first epoxy resin and/or the second epoxy resin. The concentration of the first or second epoxy resin is as described above. The concentration of the reaction product can be the same as the total concentration of the first and second modified epoxy compounds described above.

The epoxy resin composition of the present invention can be prepared using any known methods. Preparation of the epoxy resin composition of the present invention may comprise the steps of: providing a raw material epoxy resin of Formula (I) described above (hereinafter “first raw material epoxy resin”), reacting cardanol with the first raw material epoxy resin, and mixing the resultant compound from the previous step with a raw material epoxy resin of Formula (II) described above (hereinafter “second raw material epoxy resin”).

Alternatively, the epoxy resin composition of the present invention may be prepared by reacting cardanol with the second raw material epoxy resin, and mixing the resultant compound with the first raw material epoxy resin.

The epoxy resin composition of the present invention can also be prepared by reacting cardanol with the first raw material epoxy resin and the second raw material epoxy resin in one step or multi-steps. When the epoxy resin composition of the present invention also comprises the second modified epoxy compound of Formula (IV), the epoxy resin composition can be obtained substantially the same as described above except that both cardanol and cardol are used to react with the first raw material epoxy resin and/or the second raw material resin. Any of the above-mentioned optional components may also be added to the composition during or after reacting cardanol and, if present, cardol with the first raw material epoxy resin and/or the second raw material resin. Preferably, CNSL is used to react with the first and/or second raw material epoxy resin(s) when preparing the epoxy resin composition of the present invention. In some embodiments of the present invention, CNSL may comprise cardanol in an amount of 50 wt % or more, 60 wt % or more, 70 wt % or more, or even 80 wt % or more, based on the total weight of CNSL. CNSL may also comprise cardol in an amount of 50 wt % or less, 40 wt % or less, 20 wt % or less, 10 wt % or less, or even 5 wt % or less, based on the total weight of CNSL.

The total amount of the first raw material epoxy resin used for preparing the epoxy resin composition is, based on the total weight of raw materials, desirably 40 wt % or higher, preferably 50 wt % or higher, and more preferably 70 wt % or higher. At the same time, the total amount of the first raw material epoxy resin is desirably 95 wt % or lower, preferably 90 wt % or lower, and more preferably 80 wt % or lower. “Raw materials” comprises the first raw material epoxy resin, the second raw material epoxy resin, and cardanol and, if present, cardol.

The concentration of the second raw material epoxy resin used for preparing the epoxy resin composition, based on the total weight of raw materials, is desirably 5 wt % or higher, preferably 10 wt % or higher, and more preferably 15 wt % or higher. At the same time, the concentration of the second raw material epoxy resin is desirably 50 wt % or lower, 45 wt % or lower, and more preferably 35 wt % or lower.

Cardanol useful for preparing the epoxy resin composition of the present invention is a component of CNSL that is an oil isolated from the shell of the cashew nut. The structure of cardanol is a phenol which contains one hydroxyl group and an aliphatic side chain R in the meta-position, as shown in the following structure:

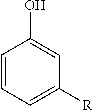

wherein R is as previously defined with reference to Formula (III).

The amount of cardanol used for preparing the epoxy resin composition is, based on the total weight of raw materials, desirably 4 wt % or higher, preferably 7 wt % or higher, and more preferably 10 wt % or higher. At the same time, the amount of cardanol is desirably 30 wt % or lower, preferably 25 wt % or lower, and more preferably 20 wt % or lower. Cardol useful for preparing the epoxy resin composition of the present invention has the following structure:

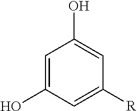

wherein R is independently as previously defined with reference to Formula (III).

Cardol may also be a component of CNSL. When used, the concentration of cardol, based on the total weight of raw materials, is desirably 0.1 wt % or higher, preferably 0.5 wt % or higher, and more preferably 1 wt % or higher. At the same time, the concentration of cardol is desirably 10 wt % or lower, preferably 7 wt % or lower, and more preferably 5 wt % or lower.

In preparing the epoxy resin composition of the present invention, reacting cardanol and, if present, cardol, or CNSL, with the raw material epoxy resin(s) can be conducted according to known methods, for example, a modification reaction wherein the active hydrogen atom in cardanol and, if present, cardol, is reacted with epoxide group(s) of the raw material epoxy resin. The modification reaction described above may be conducted in the presence or absence of a solvent with the application of heating and mixing. The reaction temperature may be from 20 to 260° C., preferably from 80 to 200° C., and more preferably from 100 to 180° C. In general, the time for completion of the modification reaction may range from 5 minutes to 24 hours, preferably from 30 minutes to 8 hours, and more preferably from 30 minutes to 4 hours. A catalyst is preferably to be added in the modification reaction. Examples of suitable catalysts for the modification reaction include basic inorganic reagents, phosphines, quaternary ammonium compounds, phosphonium compounds and tertiary amines. Preferably, catalysts suitable for the modification reaction include NaOH, potassium hydroxide (KOH), ethyl triphenyl phosphonium acetate, imidazole, or triethylamine. The catalyst useful in the present invention may be used in an amount from 0.01 to 3 wt %, preferably from 0.03 to 1.5 wt %, and more preferably from 0.05 to 1.5 wt %, based on the total weight of the raw material epoxy resin(s). In some embodiments of the present invention, the raw material epoxy resin(s), cardanol, and if present, cardol are mixed in proper amounts as described above, and are dissolved and heated under conditions of the modification reaction as described above to form the epoxy resin composition of the present invention.

The epoxy resin composition of the present invention may be a liquid mixture or a semi-solid mixture. The epoxy resin composition may have an EEW of 195 or more, preferably 220 or more, and more preferably 240 or more. At the same time, the EEW of the epoxy resin composition is desirably 400 or less, preferably 350 or less, and more preferably 320 or less.

The epoxy resin composition of the present invention may be cured using a curing agent (also known as “crosslinking agent” or “hardener”) having an active group being reactive with an epoxy group of the epoxy resin composition. Examples of suitable curing agents useful in the present invention include anhydrides, nitrogen-containing compounds such as amines and their derivatives, oxygen-containing compounds, sulfur-containing compounds, aminoplasts, polyisocyanates including blocked isocyanates, beta-hydroxyalkylamides, polyacids, anhydrides, organometallic acid-functional materials, polyamines, polyamides, and mixtures thereof. Amine-based curing agents are preferred. More preferably, the curing agent comprises a phenalkamine curing agent, which is known to be able to cure epoxy resins at a temperature as low as −5° C. Surprisingly, when the epoxy resin composition of the present invention is cured with the phenalkamine curing agent, the resultant product can still have comparable or even better flexibility than a conventional bisphenol A epoxy resin being cured by a polyamide curing agent.

Curing the epoxy resin composition of the present invention may be carried out, for example, at a temperature in a range of from −10 to 300° C., preferably from −5 to 250° C., more preferably 10 to 220° C., and most preferably from 21 to 25° C. Generally, the time for curing or partially curing the epoxy resin composition is from 2 seconds to 24 days, preferably from 0.5 hour to 7 days, and more preferably from one hour to 24 hours. It is also operable to partially cure the epoxy resin composition of the present invention and then complete the curing process at a later time. In one embodiment, the epoxy resin composition is cured by an amine curing agent at ambient temperature.

In addition to the epoxy resin composition described above, the curable coating composition of the present invention also comprises a curing agent. The curing agent may comprise a phenalkamine compound, its adduct, or mixtures thereof.

The phenalkamine compound useful in the present invention may comprise a reaction product of cardanol, formaldehyde, and a polyamine (for example, ethylenediamine) through the Mannich reaction. Suitable commercially available phenalkamine compounds useful in the present invention include for example CARDOLITE™ NC 541, CARDOLITE NC 541LV, and CARDOLITE NX 2015 hardeners available from Cardolite Cooperation; D.E.H.™ 641 hardener available from The Dow Chemical Company (D.E.H. is a trademark of The Dow Chemical Company); or mixtures thereof.

When present, the concentration of the phenalkamine compound, based on the total weight of the curing agent, is desirably 10 wt % or more, preferably 20 wt % or more, and more preferably 30 wt % or more. At the same time, the concentration of the phenalkamine compound is desirably 50 wt % or less, preferably 60 wt % or less, and more preferably 70 wt % or less.

Preferably, the curing agent in the curable coating composition of the present invention comprises one or more adducts of the above described phenalkamine compound (“Phenalkamine Adduct”). More preferably, the curing agent comprises a mixture of the phenalkamine compound and the Phenalkamine Adduct. The Phenalkamine Adduct useful in the present invention can be an adduct of the phenalkamine compound with an epoxy compound. The epoxy compound herein can be any epoxy resin having at least one epoxide group, for example, bisphenol A epoxy resin, bisphenol F epoxy resin, or mixtures thereof.

When present, the concentration of the Phenalkamine Adduct, based on the total weight of the curing agent, is desirably 0.5 wt % or more, preferably 5 wt % or more, more preferably 10 wt % or more, and more preferably 15 wt % or more. At the same time, the concentration of the Phenalkamine Adduct is desirably 80 wt % or less, preferably 70 wt % or less, and more preferably 60 wt % or less, and most preferably 50 wt % or less.

The curing agent useful in the curable coating composition may be used in a sufficient amount to cure the curable coating composition. A molar ratio of total epoxy functionality of the epoxy resin composition to total active hydrogen functionality of the curing agent in the curable coating composition may be 10:1 or lower, preferably 5:1 or lower, more preferably 3:1 or lower, and most preferably 2:1 or lower. At the same time, the molar ratio of total epoxy functionality of total epoxy resins to total active hydrogen functionality of the amine curing agent in the curable coating composition may be generally 1:2 or higher, preferably 1:1.5 or higher, more preferably 1:1.2 or higher, and most preferably 1:0.9 or higher.

The curing agent in the curable coating composition of the present invention optionally comprises a polyamine compound or a mixture of two or more polyamine compounds in combination with the phenalkamine curing agent. Examples of polyamines useful in the present invention include an aliphatic polyamine, an alicyclic polyamine, an aromatic polyamine, a heterocyclic polyamine, polyamide, or mixtures thereof. When used, the concentration of the above described polyamine compound generally ranges from 0.05 to 50 wt %, from 0.1 to 40 wt %, from 1 to 30 wt %, or even from 2 to 20 wt %, based on the total weight of the curing agent.

The curing agent in the curable coating composition of the present invention may comprise a catalyst. Examples of catalysts useful in the present invention include tris(dimethylaminomethyl)phenol, salicylic acid, or mixtures thereof. When used, the catalyst may be in an amount of 0.1 to 10 wt %, and preferably 0.5 to 5 wt %, based on the total weight of the curing agent.

The curing agent in the curable coating composition of the present invention may also comprise an accelerator. Examples of accelerators useful in the present invention include benzyl alcohol, nonyl phenol, or mixtures thereof. When used, the accelerator may be in an amount of 0.5 to 50 wt %, and preferably 5 to 30 wt %, based on the total weight of the curing agent.

The curable coating composition of the present invention may also include organic solvents. The components mentioned above present in the curable coating composition may be dissolved or dispersed in an organic solvent. Examples of suitable solvents include alcohols such as n-butanol; ketones; glycols such as ethylene glycol, propylene glycol, butyl glycol; glycol ethers such as propylene glycol monomethyl ether, ethylene glycol dimethyl ether; xylene; toluene; acetates such as glycol ether acetates; mineral oil; naphthas; and mixtures thereof. The organic solvent is generally present in an amount of from 5 to 60 wt %, and preferably from 8 to 20 wt %, based on the total weight of the curable coating composition.

The curable coating composition of the present invention may include inorganic extender and/or pigments. Examples of inorganic extender and/or pigments include iron oxides, calcium carbonate, precipitated silica, magnesium carbonate, talc, zinc powder, titanium dioxide, iron oxides, carbon black, metallic materials including metalloid materials, feldspar powder, or mixtures thereof. Preferably, the curable coating composition comprises anticorrosive pigments such as zinc phosphate, zinc (Zn) powder or mixtures thereof. When used, the concentration of the inorganic extenders and/or pigments in the curable coating composition is generally from 5 to 60 wt %, preferably 10 to 40 wt %, based on the total weight of the curable coating composition.

Preferably, the curable coating composition comprises Zn powder. Advantageously, the curable coating composition can comprise zinc powder in an amount of 50 wt % or more, 60 wt % or more, or even 70 wt % or more, based on the total weight of the curable coating composition. The obtained zinc-containing coating compositions can be used as sacrificial anodes to prevent steel structure from corrosion.

The curable coating composition of the present invention optionally comprises one or more additional film-forming resins that are different from the epoxy resin composition of the present invention. Examples of the additional film-forming resins include polyurethane, acrylics, alkyds, polyester, polyether, polysiloxane, and mixtures thereof.

In addition to the foregoing components, the curable coating composition of the present invention can further comprise, or be free of, any one or combination of more than one of the following additives: anti-foaming agents, plasticizers, leveling agent, wetting agent, dispersant, thixotropic agents, adhesion promoter, diluents and grind vehicles. When present in the curable coating composition, these additives may be in an amount of 0.001 to 10 wt %, and preferably 0.01 to 2 wt %, based on the total weight of the curable coating composition.

The curable coating composition may be prepared with techniques known in the coating art. The curable coating composition can be prepared by admixing the epoxy resin composition and the curing agent, which are preferably dissolved in the organic solvent. Other optional components including for example inorganic extenders and/or pigments and/or other optional additives may also be added, as described above. Components in the curable coating composition may be mixed in any order to provide the curable coating composition of the present invention. Any of the above-mentioned optional components may also be added to the composition during the mixing or prior to the mixing to form the curable coating composition.

The curable coating composition of the present invention can be similarly cured under the conditions used for curing the epoxy resin composition to form a coating film. Preferably, the curable coating composition is cured at 25° C. or lower, or even 0° C. or lower.

Surprisingly, the curable coating composition of the present invention have a volume solids content of 60% or more, 65% or more, or even 70% or more. “Volume solids content” is determined by the test method described in the Examples section below. At the same time, the curable coating composition can be applied by incumbent means including brushing, dipping, rolling and spraying. The curable coating composition is preferably applied by spraying. The standard spray techniques and equipment for spraying such as air-atomized spraying, air spray, airless spray, high volume low pressure spray, and electrostatic spraying such as electrostatic bell application, and either manual or automatic methods can be used.

The curable coating composition of the present invention has shorter dry-hard time relative to the conventional liquid epoxy resins-based coating compositions. The curable coating composition of the present invention can also provide a coating film made therefrom with several advantages. For example, the coating film has better flexibility, as compared to that of conventional bisphenol A epoxy resin-based coating compositions. The coating film shows good chemical resistance, as evidenced by no blister after being immersed in 10% NaOH or 10% H₂SO₄ solution for at least 7 days according to the ISO 4628/1 method. The coating film can have a pendulum hardness of at least 60 seconds as measured by the ISO 1522 method, 70 seconds or more, 80 seconds or more, or even 90 seconds or more. The coating film can have good anti-corrosion property to sustain at least 600 hours salt-spray testing as determined by the ASTM B-117 method, 700 hours or more, 1,000 hours or more, 1,200 hours or more, 2,000 hours or more, or even 3,000 hours or more.

The curable coating composition of the present invention can be applied to, and adhered to, various substrates. Examples of substrates include wood, metals, plastic, foam, stone, including elastomeric substrates, glass, fabric, concrete, cementious substrates, or substrates that are found on motor vehicles. The curable coating composition of the present invention is suitable for various coating applications, such as marine and protective coatings, automotive coatings, wood coatings, coil coatings, plastic coatings, powder coatings, can coatings, and civil engineering coatings. The curable coating composition is particularly suitable for heavy duty anticorrosive primers (for example, zinc-rich coatings). The curable coating composition can be used alone, or in combination with other coatings to form multi-layer coatings. For example, a multi-layer coating may comprise the curable coating composition of the present invention as a primer, a tie coat and, optionally, a topcoat.

### Examples

The following examples illustrate embodiments of the present invention. All parts and percentages in the examples are by weight unless otherwise indicated. The following materials are used in the examples:

Cashew nut shell liquid 1 (“CNSL-1”), available from Beijing Huada Saigao, comprises more than 90 wt % of cardanol, based on the total weight of CNSL-1.

Cashew nut shell liquid 2 (“CNSL-2”), available from Beijing Huada Saigao, comprises about 60 wt % of cardanol and about 40 wt % of cardol, based on the total weight of CNSL-2.

D.E.R. 671 resin, available from The Dow Chemical Company, is a diglycidylether of bisphenol A that has an EEW of 420-550.

D.E.R. 331 resin, available from The Dow Chemical Company, is a diglycidyl ether of bisphenol A that has an EEW of 182-192.

Ethyl triphenyl phosphonium acetate is a catalyst available from The Dow Chemical Company.

CARDOLITE NC 541 hardener, available from Cardolite Corporation, is a phenalkamine hardener that has an amine value of 300-335.

ANCAMINE™ K 54 catalyst is 2,4,6-tris [(dimethylamino)methyl]-phenol available from Air Products and Chemicals, Inc.

Benzyl alcohol is an accelerator available from Sinopharm Chemical Reagent Co., Ltd.

Xylene is a solvent available from Sinopharm Chemical Reagent Co., Ltd.

Isobutanol is a solvent available from Sinopharm Chemical Reagent Co., Ltd.

Talc is pigment, available from Shanghai Wanjiang Chemical Company.

THIXATROL™ PLUS additive is used as a leveling agent, available from Elementis Specialties.

Zinc powder is available from Shijiazhuang Xinri Zinc Company.

Iron oxide is available from Lanxess Company.

Pedspar powder is available from Dexin Mineral Powder Processing Company.

DOWANOL™ PM glycol ether is propylene glycol monomethyl ether (PGME) used as solvent, available from The Dow Chemical Company.

VERSAMID™ 115 polyamide is used as a hardener available from BASF.

Butanol is a solvent available from Sinopharm Chemical Reagent Co., Ltd.

The following standard analytical equipment and methods are used in the Examples.

### Epoxide Equivalent Weight (EEW) Analysis

A standard titration method is used to determine percent epoxide in various epoxy resins. The titration method used is similar to the method described in Jay, R.R., “Direct Titration of Epoxy Compounds and Aziridines”, Analytical Chemistry, 36, 3, 667-668 (March 1964). In the present adaptation of this method, the carefully weighed sample (sample weight ranges from 0.17-0.25 gram) was dissolved in dichloromethane (15 milliliter (mL)) followed by the addition of tetraethylammonium bromide solution in acetic acid (15 mL). The resultant solution treated with 3 drops of crystal violet indicator (0.1% wt/vol in acetic acid) was titrated with 0.1 N perchloric acid in acetic acid on a Metrohm 665 Dosimat titrator (Brinkmann). Titration of a blank consisting of dichloromethane (15 mL) and tetraethylammonium bromide solution in acetic acid (15 mL) provided correction for solvent background. Percent epoxide and EEW are calculated using the following equations:

% Epoxide=[(mL,titrated sample)−(mL titrated blank)]×(0.4303)/(gram sample titrated)

EEW=43023/[% Epoxide]

### Volume Solids Content

The volume solids content of a coating composition is calculated as follows. The total volume of pigment and inorganic extender in the coating composition is denoted as V. The total volume of non-volatile solids except pigment and inorganic extender in the coating composition (also known as “volume of solid binder”) is denoted as V_{b}. The total volume of the coating composition (also known as “total wet paint volume”) is denoted as V_{w}. The volume solids content of the coating composition is measured according to the following equation:

Volume solids=[(Vₚ+V_{b})/V_{w}]×100%

### Pull Off Adhesion Strength

A coating composition is coated on a blasted steel panel (3 millimeter (mm) thickness) to form a coating film. The coating film has an average thickness of 100-120 microns. The pull-off adhesion strength of the coating film is measured in accordance with the ISO 4624 method.

### Viscosity

The viscosity of an epoxy resin composition is measured at 50° C. using a Brookfield CAP 2000+ viscometer, 6# rotator, and 100 revolutions per minute (rpm).

### Pot Life

The pot life of a coating composition is measured by the period from the start of mixing “Part A” and “Part B” of the coating composition till the viscosity of the coating composition reaches 2,000 centipoises (cps). Definition of Part A and Part B are described below. The viscosity of the coating composition is measured at room temperature using a Brookfield CAP 2000+ viscometer, 6# rotator, and 100 rpm.

### Dry-Hard Time

A BYK drying recorder is used to record dry-hard time of a coating composition according to the ASTM D 5895 method. The coating composition to be evaluated is coated on a glass panel and then put on to the BYK drying timer for drying at room temperature.

### Pendulum Hardness

A coating composition is coated on a blasted steel panel to form a coating film with an average thickness of 60-100 microns. Pendulum hardness of the coating film is evaluated in accordance with the ISO 1522 method.

### Conical Mandrel Flexibility Test

Conical mandrel flexibility is conducted to evaluate the ability of a coating film to resist cracking in accordance with the ASTM D 522 method. A coating composition to be evaluated is directly sprayed onto a tin plate to form a coating film The coating film has an average thickness of 30-40 microns. The smaller the crack distance, the better flexibility of the coating film.

### Chemical Resistance

A coating composition is coated on a Q panel to form a coating film with an average thickness of 60-100 microns. The coated panel is dried at room temperature for about 7 days, and is then immersed in 10% NaOH solution or 10% H₂SO₄ solution, respectively. After immersion for 7 days, using an absorbent medium method, the panel is evaluated for any signs of deterioration of the coating according to the ISO 4628/1 method.

### Methyl Ethyl Ketone (MEK) Resistance

A coating composition is coated on a Q panel and dried at 0° C. for 4 days to form a film with an average thickness of 60-80 microns. Manual 25 double rubs are carried out with cloth soaped with MEK. The MEK resistance is defined as the following levels:
5—No effect on film surface, and no paint on cloth after 25 double rubs;
4—Burnished appearance in rubbed area of the film, and slight amount of paint on cloth after 25 double rubs;
3—Some marring and apparent loss of gloss of the film after 25 double rubs;
2—Heavy marring and obvious depression in the film after 25 double rubs;
1—Heavy depression in the film but no actual penetration to the substrate after 25 double rubs;
0—Penetration to the Q panel substrate up to 25 double rubs.

### Salt-Spray Test

A coating composition is coated on a blasted steel substrate and cured at room temperature for 7 days to obtain a coating film. The coating film has an average thickness of 100-120 microns. Salt-spray resistance of the coating film is determined by the ASTM B117 method.

### Preparation of COMPOUND I

D.E.R. 671 resin was mixed with CNSL-1 or CNSL-2 under nitrogen atmosphere in a flask. After D.E.R. 671 resin was completely dissolved at 120-130° C., 200 ppm ethyl triphenyl phosphonium acetate (in 70 wt % methanol solution) was added as a catalyst. The resultant mixture was heated to 160° C. and kept at this temperature for 2 hours to obtain COMPOUND I. COMPOUND I used in the following examples is prepared as described above.

### Preparation of COMPOUND II

D.E.R. 331 resin was mixed with CNSL-1 or CNSL-2 under nitrogen atmosphere in a flask. After the mixture reached 90° C., 200 ppm ethyl triphenyl phosphonium acetate (in 70 wt % methanol solution) was added as a catalyst. The resultant mixture was heated to 160° C. and kept at this temperature for 2 hours to obtain COMPOUND II. COMPOUND II used in the following examples is prepared as described above.

### Examples (Exs) 1-2

Epoxy resin compositions of Exs 1-2 were prepared based on formulations shown in Table 1. COMPOUND I was prepared according to the procedure described above, then mixed with D.E.R. 331 resin to obtain the epoxy resin compositions. Details of the resulting epoxy resin compositions obtained from the above procedure were reported in Table 4.

TABLE 1

| Raw Material (gram) | | Ex 1 | Ex 2 |
|---|---|---|---|
| For | CNSL | 6 (CNSL-1) | 10 (CNSL-1) |
| COMPOUND I | D.E.R. 671 resin | 30 | 45 |

| | | |
|---|---|---|
| D.E.R. 331 resin | 64 | 45 |

### Exs 3-5

Epoxy resin compositions of Exs 3-5 were prepared based on formulations shown in Table 2. COMPOUND II was prepared according to the procedure described above, then mixed with D.E.R. 671 resin to obtain the epoxy resin compositions. Details of the resulting epoxy resin compositions obtained from the above procedure were reported in Table 4.

TABLE 2

| Raw Material (gram) | | Ex 3 | Ex 4 | Ex 5 |
|---|---|---|---|---|
| For | CNSL | 6 (CNSL-1) | 13 (CNSL-1) | 8 (CNSL-2) |
| COMPOUND II | D.E.R. 331 resin | 74 | 77 | 77 |

| | | | |
|---|---|---|---|
| D.E.R. 671 resin | 20 | 10 | 15 |

### Exs 6-8

Epoxy resin compositions of Exs 6-8 were prepared based on formulations shown in Table 3. COMPOUND I and COMPOUND II were prepared according to the procedure described above, then were mixed together to obtain the epoxy resin compositions. Details of the resulting epoxy resin compositions obtained from the above procedure were reported in Table 4.

TABLE 3

| Raw Material (gram) | | Ex 6 | Ex 7 | Ex 8 |
|---|---|---|---|---|
| For | CNSL | 2 (CNSL-1) | 4.5 (CNSL-1) | 2.65 (CNSL-2) |
| COMPOUND I | D.E.R. 671 resin | 20 | 28 | 23 |
| For | CNSL | 5 (CNSL-1) | 12.5 (CNSL-1) | 7.35 (CNSL-2) |
| COMPOUND II | D.E.R. 331 resin | 73 | 55 | 67 |

TABLE 4

| | Epoxy Resin Composition (Weight percentage relative to the total | | | | | | | |
|---|---|---|---|---|---|---|---|---|
| | weight of epoxy resin composition) | | | | | | | |
| | Ex 1 | Ex 2 | Ex 3 | Ex 4 | Ex 5 | Ex 6 | Ex 7 | Ex 8 |
| D.E.R. 671 resin | 11.2 | 13.7 | 20.0 | 10 | 15 | 13.7 | 13.9 | 11.4 |
| D.E.R. 331 resin | 64.0 | 45.0 | 66.5 | 60.8 | 63.0 | 66.8 | 39.4 | 54.2 |
| Cardanol-modified | 24.8 | 41.3 | 13.5 | 29.2 | 10.8 | 19.5 | 46.7 | 16.4 |
| epoxy resin | | | | | | | | |
| Cardol-modified | — | — | — | — | 11.2 | — | — | 18 |
| epoxy resin | | | | | | | | |
| EEW* | 259 | 330 | 239 | 256 | 246 | 244 | 337 | 277 |
| Viscosity (cps) | 7570 | 11255 | 5230 | 756.5 | 12570 | 5776 | 9130 | 15124 |

*EEW of the epoxy resin composition

### Comparative Example (Comp Ex) A

Ninety two (92) grams of D.E.R. 671 resin and 8 grams of CNSL-1 were mixed under nitrogen condition in a flask. After D.E.R. 671 resin was completely dissolved at 120-130° C., 200 ppm ethyl triphenyl phosphonium acetate (in 70 wt % methanol solution) was added as a catalyst. The resultant mixture was heated to 160° C. and kept at this temperature for 2 hours to obtain the epoxy resin composition of Comp Ex A. Details of the resulting epoxy resin composition obtained from the above procedure were reported in Table 6.

### Comp Ex B

Eighty (80) grams of D.E.R. 331 resin and 20 grams of CNSL-2 were mixed under nitrogen condition in a flask. After the mixture reached 90° C., 200 ppm ethyl triphenyl phosphonium acetate (in 70 wt % methanol solution) was added as a catalyst. The resultant mixture was heated to 160° C. and kept at this temperature for 2 hours to obtain the epoxy resin composition of Comp Ex B. Details of the resulting epoxy resin composition obtained from the above procedure were reported in Table 6.

### Comp Ex C

Comp Ex C was prepared substantially the same as described in KR559055B1 where no catalyst was used. In the flask equipped with a condenser and a stirrer were introduced 90 grams of D.E.R. 331 and 10 grams of CNSL-1 and then the temperature was elevated up to 140° C. After the reaction was maintained for 5 hours, cooling was carried out to obtain epoxy resin composition of Comp Ex C. Gas chromatography-mass spectrometry (GC-MS) method showed that the resultant epoxy resin composition comprises unreacted cardanol, and less than 5 wt % of cardanol-modified epoxy resin, based on the total epoxy resin composition. Details of the resulting epoxy resin compositions obtained from the above procedure were reported in Table 6.

### Comparative Examples (Comp Exs) D and E

Epoxy resin compositions of Comp Exs D and E were prepared based on formulations shown in Table 5. COMPOUND I and COMPOUND II were prepared according to the procedure described above, then mixed together to obtain the epoxy resin compositions. Details of the resulting epoxy resin compositions obtained from the above procedure were reported in Table 6.

TABLE 5

| Raw Material (gram) | | Comp Ex D | Comp Ex E |
|---|---|---|---|
| For | CNSL | 4 (CNSL-1) | 3 (CNSL-2) |
| COMPOUND I | D.E.R. 671 resin | 16 | 15 |
| For | CNSL | 20 (CNSL-1) | 22 (CNSL-2) |
| COMPOUND II | D.E.R. 331 resin | 60 | 60 |

TABLE 6

| | Epoxy Resin Composition (Weight | | | | |
|---|---|---|---|---|---|
| | percentage relative to the total | | | | |
| | weight of epoxy resin composition) | | | | |
| | Comp | Comp | Comp | Comp | Comp |
| | Ex A | Ex B | Ex C | Ex D | Ex E |
| D.E.R. 671 resin | 66.9 | — | — | 3.5 | 1.8 |
| D.E.R. 331 resin | — | 44.5 | >87.2 | 35.1 | 21.6 |
| Cardanol-modified | 33.1 | 27.2 | <5 | 61.4 | 37.1 |
| Epoxy Resin | | | | | |
| Cardol-modified | — | 28.3 | — | — | 39.5 |
| Epoxy Resin | | | | | |
| CNSL | — | — | >7.8 | — | — |
| EEW* | 591 | 299 | 208 | 364 | 425.5 |
| Viscosity (cps) | solid | 554.7 | N/A** | — | — |
| | at | | | | |
| | 50° C. | | | | |

*EEW of the epoxy resin composition.
**Viscosity was too low to be measured.

Viscosities of epoxy resin compositions of the present invention and Comp Exs were measured according to the test method describe above, and given in Table 4 and 6, respectively. Compared to the epoxy resin composition of Comp Ex A and D.E.R. 671 resin (both solid at 50° C.), the epoxy resin compositions of Exs 1-8 showed much lower viscosity. Therefore, the epoxy resin compositions of the present invention are more suitable for high solids coating formulations.

### Coating Compositions 1-8

“Hardener 1” was prepared by mixing 2 wt % of ANCAMINE K 54 catalyst, 75 wt % of phenalkamine, 3 wt % of benzyl alcohol, 15 wt % of xylene, and 5 wt % of isobutanol, based on the total weight of Hardener 1. Then, clear coating compositions were prepared by mixing Hardener 1 with the epoxy resin compositions of Exs 1-8 obtained above, respectively, based on formulations shown in Table 7.

The obtained coating compositions of the present invention were sprayed onto a substrate, and were then dried at room temperature for 7 days unless otherwise indicated for performance tests.

TABLE 7

| | | Coating Composition | | | | | | | |
|---|---|---|---|---|---|---|---|---|---|
| | | (Weight percentage relative to the total | | | | | | | |
| | | weight of the coating composition) | | | | | | | |
| | | 1 | 2 | 3 | 4 | 5 | 6 | 7 | 8 |
| Epoxy Resin | Ex 1 | 61 | | | | | | | |
| Composition | Ex 2 | | 66 | | | | | | |
| | Ex 3 | | | 59 | | | | | |
| | Ex 4 | | | | 61 | | | | |
| | Ex 5 | | | | | 60 | | | |
| | Ex 6 | | | | | | 60 | | |
| | Ex 7 | | | | | | | 67 | |
| | Ex 8 | | | | | | | | 62 |
| Hardener | Hardener | 39 | 34 | 41 | 39 | 40 | 40 | 33 | 38 |
| | 1 | | | | | | | | |

### Comp Coating Compositions A-H

Comp Coating Compositions A-H were prepared by mixing comparative epoxy resin compositions or conventional epoxy resins with different hardeners, respectively, based on formulations shown in Table 8.

Drying properties of the above clear coating compositions and properties of coating films formed from these coating compositions were evaluated according to the test method described above.

TABLE 8

| | | Comp Coating Composition | | | | | | | |
|---|---|---|---|---|---|---|---|---|---|
| | | (Weight percentage relative to the total | | | | | | | |
| | | weight of the coating composition) | | | | | | | |
| | | A | B | C | D | E | F | G | H |
| Epoxy | Comp Ex A | 78 | | | | | | | |
| Resin | Comp Ex B | | 64 | | | | | | |
| Composition | Comp Ex C | | | 55 | | | | | |
| | Comp Ex D | | | | 69 | | | | |
| | Comp Ex E | | | | | 72 | | | |
| | D.E.R. 331 resin | | | | | | 53 | | |
| | D.E.R. 671 resin | | | | | | | 74 | |
| | D.E.R. 671 resin | | | | | | | | 54 |
| Hardener | Hardener 1 | 22 | 36 | 45 | 31 | 28 | 47 | 26 | |
| | VERSAMID 115 | | | | | | | | 23 |
| | Xylene | | | | | | | | 23 |

Table 9 shows dry-hard time of the clear coating compositions. Comp Coating Compositions B-E showed a dry-hard time of 3.9 hours or longer. In contrast, Coating Compositions 1-8 of the present invention show a dry-hard time of 2.4 hours or less, which is much shorter than that of Comp Coating Compositions B-E.

TABLE 9

| | Coating Composition | | | | | | | | | | | |
|---|---|---|---|---|---|---|---|---|---|---|---|---|
| | 1 | 2 | 3 | 4 | 5 | 6 | 7 | 8 | B | C | D | E |
| Dry-hard | 1.2 | <1.2 | <2.4 | 2.4 | <2.4 | 2.1 | <2.1 | <2.1 | 4.8 | 8.2 | 4.8 | 3.9 |
| Time (hour) | | | | | | | | | | | | |

Table 10 shows crack distance of coating films made from the above clear coating compositions in the conical mandrel flexibility test. Compared to Comp Coating Compositions F and G, Coating Compositions 1-8 of the present invention provided coating films with smaller crack distance. It indicates that the inventive coating compositions provide coating films with better flexibility than that of clear coating compositions based on conventional epoxy resins such as D.E.R. 331 resin or D.E.R. 671 resin.

TABLE 10

| | Coating Composition | | | | | | | | | |
|---|---|---|---|---|---|---|---|---|---|---|
| | 1 | 2 | 3 | 4 | 5 | 6 | 7 | 8 | F | G |
| Crack Distance | 8.8 | 5.2 | 8.3 | 7.4 | 3.4 | 7.9 | 1.2 | 0 | >20.5 | 14.4 |
| (centimeter (cm)) | | | | | | | | | | |

Chemical resistance of coating films made from the above clear coat compositions was also evaluated. Coating films made from the Coating Compositions 1-8 had no blister after being immersed in 10% NaOH solution or 10% H₂SO₄ solution for 7 days. However, the coating film made from Comp Coating Composition C changed to light red and peeled off from the substrate after being immersed in 10% NaOH solution or 10% H₂SO₄ solution for only one day. It indicates that coating films of the inventive coating compositions have much better chemical resistance than that of Comp Coating Composition C.

In addition, low temperature curing properties of Coating Composition 5 and Comp Coating Composition H were evaluated. After being cured at room temperature or 0° C. for 7 days, Coating Composition 5 formed films with no surface cracks. After being cured at room temperature for 7 days, Comp Coating Composition H formed films with no surface cracks. However, Comp Coating Composition H after being cured at 0° C. for 7 days formed films with surface cracks. In addition, coating films made from Coating Composition 5 (dried at 0° C., 4 days) showed an MEK resistance level of 3, which is much better than that of Comp Coating Composition H having an MEK resistance level of 0.

### Paint 9 and Comp Paint I

Paint 9 and Comp Paint I were prepared based on formulations shown in Table 11. Part A was prepared by dispersing inorganic extender and pigment and other additives into an epoxy resin composition and solvent by a high-speed dispersing machine.

Part B was prepared as follows. D.E.R. 331 resin was added into phenalkamine while stirring. Then, the temperature was raised to 60° C., and kept at this temperature for 2 hours. A catalyst, an accelerator and solvents were further added into the mixture. The resultant mixture was stirred until it became homogenous to form Part B.

Part A and Part B obtained above were mixed to form Paint 9 and Comp Paint I, respectively. The paints obtained were sprayed onto a substrate using air spray, and were then dried at room temperature for 7 days unless otherwise indicated to form films for performance tests.

TABLE 11

| | |
|---|---|
| Paint 9 | Comp Paint I |

Weight percentage relative
to the total weight of the
coating composition

| | | | |
|---|---|---|---|
| Part A | Epoxy resin | 6.92 | — |
| | composition of | | |
| | Ex 3 | | |
| | Epoxy resin | — | 7.56 |
| | composition of | | |
| | Comp Ex B | | |
| | Talc | 7.31 | 7.18 |
| | Leveling agent | 0.97 | 0.95 |
| | Zinc powder | 71.30 | 71.27 |
| | Xylene | 5.78 | 5.67 |
| | PGME | 1.83 | 1.89 |
| Part B | D.E.R. 331 resin | 0.22 | 0.22 |
| | Phenalkamine | 3.36 | 3.01 |
| | Benzyl alcohol | 0.56 | 0.55 |
| | DMP 30 | 0.11 | 0.11 |
| | Xylene | 1.06 | 1.04 |
| | Butanol | 0.56 | 0.55 |

Properties of the coating films made from the above paints were shown in Table 12. Hardness of the coating film made from Comp Paint I was only 47 seconds, which is not acceptable. The zinc-rich coating industry usually requires coating films having a hardness of at least 60 seconds. In contrast, the coating film made from Paint 9 had a hardness of 91 seconds. Paint 9 also had a high zinc content of 79 wt %, a high volume solids content of 70%, and excellent anti-corrosion property (no bubble or rust on the film after 3,000 hours salt-spray test). At the same time, the coating film made from Paint 9 showed balanced properties of high pull-off adhesion strength, long pot life, high hardness and good flexibility.

TABLE 12

| | Paint 9 | Comp Paint I |
|---|---|---|
| Zn % (weight percentage | 79 | — |
| in dry film) | | |
| Volume solids (%) | 70 | — |
| Pull off adhesion strength | >10 | — |
| (megapascal (MPa)) | | |
| Pot life (hour) | >5 | — |
| Hardness (second) | 91 | 47 |
| Crack distance (cm) | 1.2 | — |
| Salt-spray test (hour) | no bubble and rust | — |
| | on the film after | |
| | 3,000 hours test | |

### Paint 10 and Comp Paint J

Paint 10 and Comp Paint J were prepared, based on formulations shown in Table 13. Part A and Part B were prepared according the procedure as described in preparing Paint 9, respectively. Part A and Part B were then mixed together to form Paint 10 and Comp Paint J, respectively. The paints obtained were sprayed onto a substrate using air spray, and were then dried at room temperature for 7 days unless otherwise indicated to form films for performance tests.

Properties of the above anti-corrosion paints and the resultant coating films are shown in Table 14. Viscosity of the epoxy resin composition of Comp Ex A was very high, which could be formulated into a paint with a volume solids content of only 50% (Comp Paint J). In contrast, Paint 10 had a high volume solids content of 68%. At the same time, the coating film made from Paint 10 showed good performance, including long pot life, high film hardness and good flexibility and good anti-corrosion property (no bubble or rust on the film after 1,200 hours salt-spray test) to meet industrial requirements.

TABLE 13

| | | Paint 10 | Comp Paint J |
|---|---|---|---|
| | | Weight percentage relative | |
| | | to the total weight of the | |
| | | coating composition | |
| Part A | Epoxy resin composition | 27.00 | — |
| | of Ex 5 | | |
| | Epoxy resin composition | — | 24.00 |
| | of Comp Ex A | | |
| | Iron oxide | 1.56 | 1.75 |
| | Leveling agent | 0.98 | 0.80 |
| | Feldspar powder | 38.80 | 33.31 |
| | Xylene | 8.00 | 21.18 |
| | Butanol | 3.00 | 10.25 |
| Part B | Phenalkamine | 12.35 | 5.25 |
| | Benzyl alcohol | 1.66 | 0.70 |
| | DMP 30 | 0.42 | 0.18 |
| | Xylene | 4.16 | 1.72 |
| | Butanol | 2.08 | 0.86 |

TABLE 14

| | Paint 10 | Comp Paint J |
|---|---|---|
| Volume solids (%) | 68 | 50 |
| Pull off adhesion (MPa) | >15 | — |
| Pot life (hour) | 2.5 | — |
| Hardness (second) | 90 | — |
| Crack distance (cm) | 3.2 | — |
| Salt-spray test (hour) | no bubble and rust | — |
| | on the film after | |
| | 1,200 hours test | |

What is claimed is:

1. An epoxy resin composition comprising, based on the total weight of the epoxy resin composition,
(a) from 35 to 75 weight percent of a first epoxy resin of Formula (I): 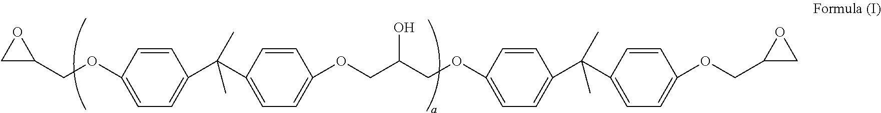
(b) from 5 to 50 weight percent of a second epoxy resin of Formula (II): 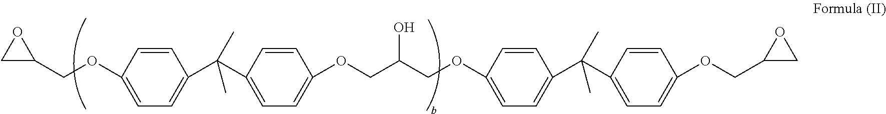
(c) from 4 to 50 weight percent of a first modified epoxy compound of Formula (III): 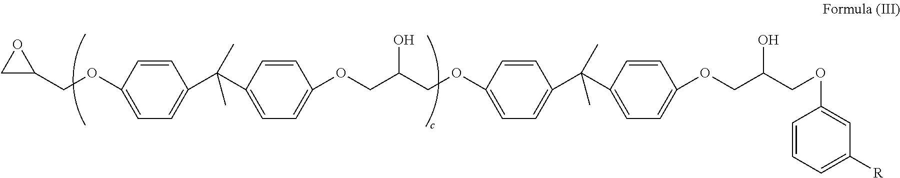
wherein a is 0 or 1, b is 2 or 3; c is 0, 1, 2 or 3; R is a straight-chain alkyl with 15 carbons containing 0 to 3 C═C bond(s) selected from the group consisting of —C₁₅H₃₁, —C₁₅H₂₉, —C₁₅H₂₇, and —C₁₅H₂₅.

2. The epoxy resin composition of claim 1, wherein the epoxy resin composition comprises (a) from 45 to 70 weight percent of the first epoxy resin, (b) from 7 to 25 weight percent of the second epoxy resin, and (c) from 10 to 40 weight percent of the first modified epoxy compound.

3. The epoxy resin composition of claim 1, wherein the first modified epoxy compound is a mixture of (i) a compound of Formula (III) wherein c is 0 or 1, and (ii) a compound of Formula UM wherein c is 2 or 3.

4. The epoxy resin composition of claim 1, wherein the first epoxy resin has an epoxide equivalent weight of 150 to 210.

5. The epoxy resin composition of claim 1, wherein the second epoxy resin has an epoxide equivalent weight of 400 to 550.

6. The epoxy resin composition of claim 1 further comprising, based on the total weight of the epoxy resin composition, (d) from 1.5 to 50 weight percent of a second modified epoxy compound having Formula (IV): 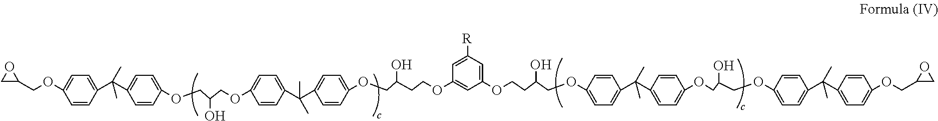
wherein c and r are independently as previously defined with reference to formula (III).

7. The epoxy resin composition of claim 6, wherein the epoxy resin composition comprises from 3 to 25 weight percent of the second modified epoxy compound.

8. The epoxy resin composition of claim 6, wherein the total content of the first modified epoxy compound and the second modified epoxy compound is from 10 to 60 weight percent, based on the total weight of the epoxy resin composition.

9. The epoxy resin composition of claim 8, wherein the total content of the first modified epoxy compound and the second modified epoxy compound is from 12 to 30 weight percent, based on the total weight of the epoxy resin composition.

10. A curable coating composition comprising (I) the epoxy resin composition of claim 1, and (II) a curing agent comprising an phenalkamine compound, its adduct, or mixtures thereof.

11. The curable coating composition of claim 10, wherein the curing agent comprises an adduct of a phenalkamine compound with an epoxy compound.

12. The curable coating composition of claim 10, wherein the curing agent comprises, based on the total weight of the curing agent, from 40 to 70 weight percent of a phenalkamine compound and/or its adduct.

13. The curable coating composition of claim 10 further comprising solvent, an accelerator, a catalyst, a pigment, a filler or mixtures thereof.

14. The curable coating composition of claim 10, wherein the curable coating composition has a volume solids content of at least 60%.

15. The curable coating composition of claim 10, wherein the molar ratio of to epoxy functionality of the epoxy resin composition to total active hydrogen functionality of the curing agent is from 10:1 to 1:2.
